(19) United States
(12) Patent Application Publication
(10) Pub. No.: US 2004/0188966 A1
(43) Pub. Date: Sep. 30, 2004

(54) Ultimate bed carrier

(76) Inventor: James Kline, Santa Rosa, CA (US)

Correspondence Address: R'SUE POPOWICH CARON, 2750 ELMWOOD AVE., BERKELEY, CA, 94705, US

(21) Appl. No.: 10/814,460

(22) Filed: Mar. 29, 2004

Related U.S. Application Data
(60) Provisional application No. 60/459,195, filed on Mar. 29, 2003.

(51) Int. Cl. B62B 3/04

(52) U.S. Cl. 280/79.11

(57) ABSTRACT

A cart for transporting a hospital bed is decsribed. The cart includes an approximately rectangular bottom panel, between two and eight wheels physically attached to the bottom panel, and at least one approximately rectangular side panel that can be attached to one edge of the bottom panel in an approximately perpendicular arrangement. At least one panel has a notch along its upper edge. The notch is adapted for immobilizing a component of a hospital bed frame when the frame is loaded on the cart. In some arrangements, a second side panel approximately parallel to the first side panel can be attached to another edge of the bottom panel. The panels can include lining layers.

### BACKGROUND OF THE INVENTION

1. Field of the Invention

This invention relates generally to an appliance for moving equipment, and, more specifically, to a compact, wheeled carrier for transporting both large and small equipment.

2. Description of the Related Art

Presently, people who move medical and other equipment can use wheeled carriers to help them to move the equipment and avoid back and other injuries. While some carriers are suited for general purposes, others have been adapted for very specific purposes. Each carrier can suit some purposes better than others. For example a carrier that is configured to carry small bottles does not work as effectively for beds and larger equipment. A carrier that is general purpose may offer more or fewer features than are necessary for moving specific medical equipment. If a carrier is very large, it may be heavier and more cumbersome than is necessary for may purposes. If it is too small, it may not be able to do the job in one trip.

Frames for some hospital beds can be disassembled, and the pieces can be bound together for transport. Sometimes the frame base has rollers or casters that can be used for moving the bed even when the bed is packed up. But often this arrangement is not particularly useful. The wheels tend to be small and can have difficulty rolling over uneven surfaces. The beds can open during transport, resulting in the scattering of parts and possible damage.

Thus, current appliances for transporting hospital beds have major drawbacks. Multiple carriers and conveyances can be used to move split frame bed parts without damage or injury. In other cases, multiple trips are made, transporting just one or two pieces at a time.

For example, the “Bed Buggy,” offered by Invacare Corporation can transport split or assembled bedsprings. This device transports only the bedspring and no other parts associated with a standard hospital bed, such as mattress and bedding. The “Bed Buggy” is useful only for transporting bedsprings within the same building rather than from a warehouse to a truck and to a final destination.

Another example of a bed transport device is the “Stor-A-Bed,” also offered by Invacare Corporation. With this device, the headboard and the footboard, can be pushed close together as the bed frame folds. The unit can be moved along on the small wheels at the bases of the headboard and footboard. However, with this system, the cross pieces that connect the headboard to the footboard can become disengaged as the bed is moved, and the arrangement comes apart. The pieces can fall to the ground, resulting in damage to the bed. Further, extra conveyances and parts cause an increase in complexity that is costly and confusing.

It would be useful to have a single appliance, such as a carrier, that can transport both large bed frames, mattresses, and small equipment, can be carried easily in a delivery truck without adding much weight or taking up much room, and can reduce the occurrence of injuries to the people who make these deliveries.

There is a need, therefore for a better device that is more versatile for moving equipment and apparatus so that the mover need not spend large amounts of time in moving and so that the equipment is moved efficiently and with safety.

### SUMMARY OF THE INVENTION

A cart for transporting a hospital bed is provided. The cart includes an approximately rectangular bottom panel, between two and eight wheels physically attached to the bottom panel, and at least one approximately rectangular side panel that can be attached to one edge of the bottom panel in an approximately perpendicular arrangement. At least one panel has a notch along its upper edge. The notch is adapted for immobilizing a component of a hospital bed frame when the frame is loaded on the cart. In some arrangements, a second side panel approximately parallel to the first side panel can be attached to another edge of the bottom panel. The panels can include lining layers.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1A is a side schematic view of a carrier appliance, according to an embodiment of the invention.

FIG. 1B is a schematic drawing showing a loaded cart, according to an embodiment of the invention.

FIG. 2 is a front schematic view of a carrier appliance.

FIG. 3 shows a bottom schematic view of a carrier appliance.

FIG. 4 is a perspective view a carrier appliance that contains only one side panel, according to an embodiment of the invention.

### DETAILED DESCRIPTION

Convenient and safe delivery of durable medical equipment (DME) can be made easier with the use of an appliance, such as a carrier or dolly, to transport the equipment from a warehouse to a truck and from the truck to a final destination, such as a home or hospital. DME encompasses a wide range of equipment of all sizes, shapes and weights. It has been difficult in the past to find an appliance that is both versatile enough to carry a wide variety of equipment and small and lightweight enough to be loaded into a truck easily without taking up much valuable cargo space.

The appliance as described in the embodiments herein offers universality and safety that result from the new and innovative design. These unique features that which heretofore have not been offered together in any carrier, allow the safe transport of DME and hospital beds, as well as various other equipment, which must be handled efficiently in a delivery and pickup business.

The term “bed” as used herein indicates a hospital bed as they type used in hospitals and nursing homes, as well as in private homes, for care of patients. The “bed” includes a bed frame, i.e., a headboard, a foot board, support structures between the head and the foot, and springs for supporting a mattress. “Bed” can also include mechanical and electrical devices for adjusting the position of the bed frame during use. “Bed” may or may not include a mattress.

The embodiments are illustrated in the context of an appliance for transporting durable medical equipment, such as beds, from warehouse to truck, from truck to delivery site, and back again. The skilled artisan will readily appreciate, however, that the materials and methods disclosed herein will have application in a number of other contexts where safe and efficient transport of equipment is desirable, particularly where a conveyance with a small size and low weight is desired.

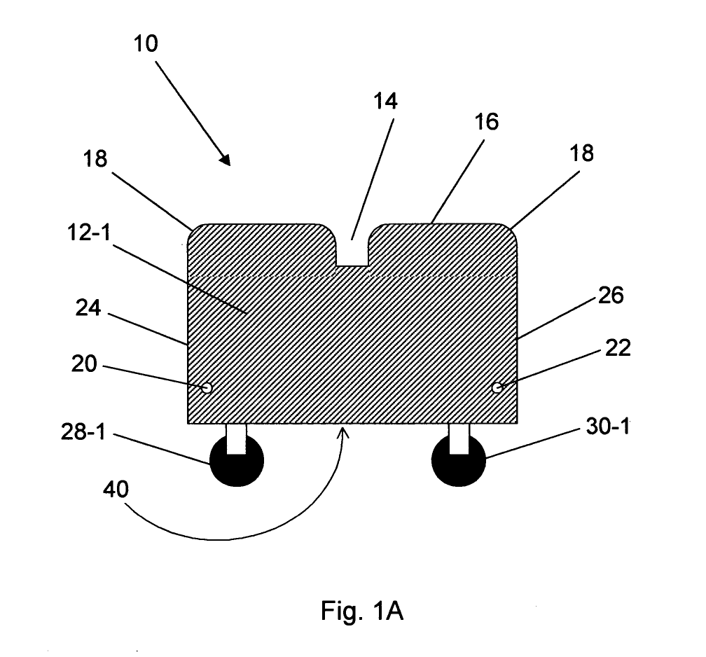

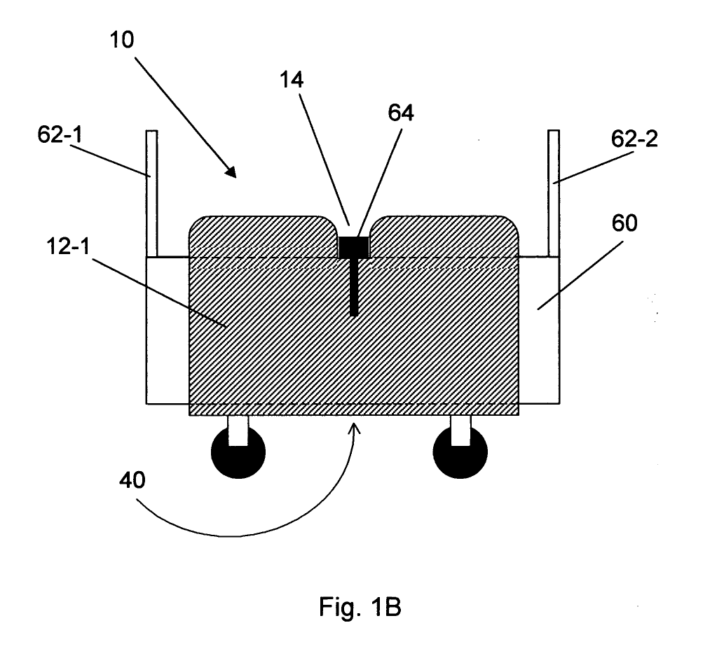

FIG. 1A is a side view of a carrier appliance 10, showing side panel 12-1, according to an embodiment of the present invention. There can be a second side panel 12-2 (not shown in this view) directly behind side panel 12-1. The side panel(s) 12-1 (12-2) are attached approximately perpendicularly to a bottom panel 40. In some arrangements, the side panels 12-1, 12-2 of the carrier 10 can be made of one or more pieces of continuous, solid material. In some arrangements, the side panels 12-1, 12-2 can include joints so that the side panels can be folded or collapsed when desired. The material can be molded plastic or polymer, wood, a composite material, such as fiberglass, or a metal, such as aluminum, titanium, or steel. In one arrangement, sheet aluminum is used, as it offers a good combination of strength and light weight. The thickness of the aluminum sheet can be between about 0.08 and 0.25 inches. In other arrangements (not shown), the sides 12-1, 12-2 can have a basic frame structure, containing tubes or rods. There may or may not be mesh or netting attached to the frame structure. The mesh or netting can be made of any of the materials described above for the panels 12-1, 12-2. Alternatively, the mesh or netting can be made of materials such as nylon, cotton, or polyester. The sides 12-1, 12-2 can be between about 25 and 35 inches in length and between about 14 and 26 inches in height. In some arrangements, the height of the side panel can be adjustable between about 14 inches and 26 inches.

A notch 14 can be provided in the top edge 16 of the side panel 12-1. A notch depth of between about 2 and 6 inches and a notch width of between about 1 and 3 inches is useful. Notches in other locations and of other sizes can be tailored to fit the specific equipment being transported. For example, extra stability for a typical hospital bed during transport can be provided by placing a crank handle of the bed in the notch 14. There can be notches only in side 12-1, only in side 12-2, or in both sides 12-1, 12-2. In some arrangements, rounded corners 18 can be provided on the top edge 16 of the side panels 12-1, 12-2. In other arrangements, the corners 18 can be square, angled or of any other shape that is easily manufactured.

There can be small holes 20, 22 near the rear edges 24 and the front edges 26, respectively, of the side panel 12-1. The holes 20, 22 provide a way for extension elements to couple to the side panel 12-1. The holes can be located anywhere along the height of the side panels 12-1, 12-2 near the rear edge 24 and the front edge 26. Alternatively, there can be any number of holes. In other arrangements, there can be one hole 20 or any number of holes only along the rear edge 24. In yet other arrangements, there can be one hole 22 or any number of holes only along the front edge 26. A fitting (not shown) can be connected to some or all of the holes 20, 22. An example of a suitable fitting is an anchor shackle. One or more extension elements, such as straps, ropes, ties, or bars (not shown) can be coupled either to the fitting(s) or directly to the hole(s). Extension elements can be flexible and made of a material such as nylon, cotton, polyester, or a composite material. An example of a suitable extension element is a nylon strap about 1.5 inches wide. In other arrangements, the extension element(s) can be rigid and made from a rod or tubing. The extension element(s) can be used to secure equipment, such as a hospital bed, to the carrier. The extension element(s) can also be used to pull and steer the carrier during transport.

The holes 20, 22 can be located any distance or distances from the rear edge 24 and the front edge 26, which allow for the attachment of straps as described. In one arrangement, there is a first hole 20, between about 0.25 and 0.50 inch in diameter, located between about 0.75 and 1.25 inches from the rear edge 24 of each side panel 12-1, 12-2 and between about 2 and 4 inches above the bottom panel 40 of the carrier 10. There is a similar second hole 22, similarly located with respect to the front edge 26 in each of the side panels 12-1, 12-2. The side panels 12-1, 12-2 can be identical to one another or can be configured differently within the possibilities described above.

The carrier can include 4 wheels. In the exemplary embodiment shown in FIG. 1, rear wheel 28-1 and front wheel 30-1 can be seen. Although not visible in FIG. 1, there is a second rear wheel 28-2 and a second front 30-2 directly behind wheels 28-1, 28-2, respectively. The wheels 28-1, 28-2, 30-1, 30-2 are attached to the bottom panel 40 of the carrier 10 near the rear edge 24 and the front edge 26, respectively. In other arrangements, there can be between 2 and 8 wheels. The wheels can be round bearing wheels that are suitable for transport over thresholds, steps, and gaps in the flooring. The wheels can be rigid casters or swivel casters, or some combination thereof In one arrangement, the rear wheels can be rigid casters and the front wheels can be swivel casters. In some arrangements (not shown), a front axle and a rear axle with wheels attached can be used instead of individual wheels. In other arrangements one or more axles with wheels and additional individual wheels can be used. The diameters of the wheels can be between about 4 inches and 8 inches. It is desirable that the wheels be of sufficient size to roll over surface irregularities, such as door jambs, uneven ground, and connecting apparatus between a delivery truck and an outside surface, such as pavement, while the cart is carrying a heavy load, such as a hospital bed.

FIG. 1B is a schematic drawing showing a loaded cart, according to an embodiment of the invention. The cart 10 is as seen in FIG. 1A. A foot board 60 of a hospital bed is shown loaded into the cart 10. The foot board 25 is upside down, that is, the top of the foot board 25 is positioned on the bottom panel 40 and legs 62-1, 62-1 of the foot board 25 are pointing upwards. A crank handle 64 is positioned in a notch 14 of the side panel 12-1. The crank handle 64 fits well in the notch 14 and thus locks the foot board 60 in place on the cart 10. Other pieces of a hospital bed or other equipment (not shown) can also be loaded onto the cart 10.

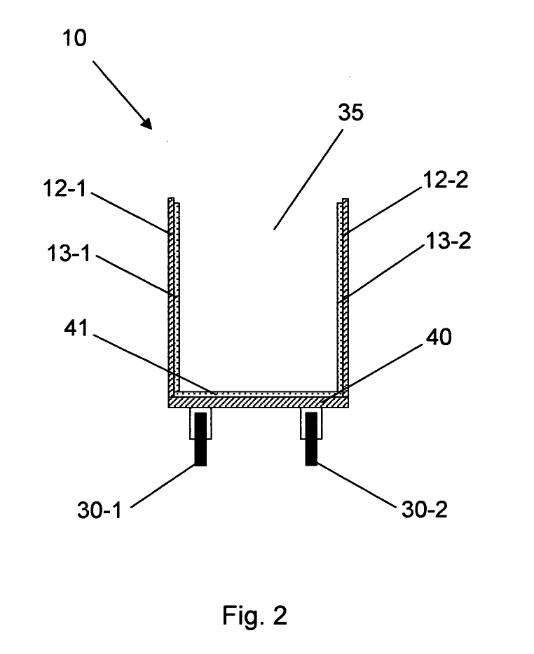

FIG. 2 shows a front view of the carrier 10. The front wheels 30-1, 30-2 are attached to the bottom panel 40 of the carrier 10. The side panels 12-1, 12-2 extend approximately perpendicularly from the outer edges of the bottom panel 40. The side panels 12-1, 12-2 can be attached to the bottom panel 40 in any number of ways, such as bolting, riveting, or welding. In some arrangements, the side panels 12-1, 12-2 can be attached to the bottom panel 40 with hinge mechanisms so that the side panels 12-1, 12-2 can be folded down onto the bottom panel 40 for easy transport of the cart when it is not in use for carrying DME. The hinge mechanisms can have springs to hold the side panels 12-1, 12-2 approximately perpendicular to the bottom panel 40 when desired. In other arrangements (not shown), the side panels 12-1, 12-2 can be detachably connected to the bottom panel 40. One example of a detachable connection is for the side panels 12-1, 12-2 to have tabs along their bottom, long edges, which tabs can be inserted into corresponding holes in the bottom panel 40. These insertions can be made permanent by attachment methods as described above, or they can be non-permanent to allow easy disassembly of the carrier 10. The side panels 12-1, 12-2 and the bottom panel 41 form a cavity 35 that can hold DME or other equipment for transport.

The bottom panel 40 can have a lining layer 41 along the upper panel surface. The side panels 12-1, 12-2 can have lining layers 13-1, 13-2, respectively, along their interior surfaces. The lining layers 41, 13-1, 13-2 can be made of any material that will provide cushioning and protection against damage to the DME or other equipment loaded onto the carrier 10. Examples of materials that can be used for the lining layers include felt, carpeting, foam padding, artificial turf, and plastics.

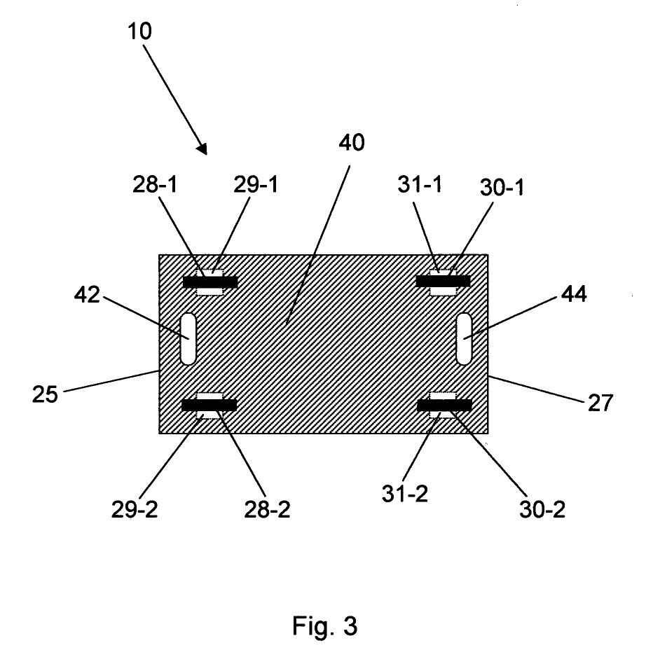

FIG. 3 shows a bottom view of the carrier 10. The bottom panel 40 has a width (distance between long edges) between about 12 and 30 inches. Widths greater than 30 inches are less useful as they do not fit easily through industrial and residential doorways. For applications where moving through doorways is not a concern, widths greater than 30 inches can be used. The bottom panel 40 can have a length (distance between short edges) between about 25 and 35 inches. The length can be made longer as required for specific applications. The bottom panel 40 of the carrier 10 can be made of any material as described above for the side panels 12-1, 12-2 in FIG. 1.

Wheels 28-1, 28-2, are shown attached to the bottom panel 40 with fittings 29-1, 29-2, respectively, near rear edge 25. Wheels 30-1, 30-2 are shown attached to the bottom panel 40 with fittings 31-1, 31-2, respectively, near front edge 27. The fittings 29-1, 29-2, 31-1, 31-2 can be attached in any number of ways, such as bolting, riveting, or welding.

There can be hand grips 42, 44 near the rear edge 25 and the front edge 27, respectively, of the bottom panel 40. The hand grips 42, 44 can be used to hold and lift the carrier 40 to move and store it when it is empty, for example, when returning the carrier 40 to a truck after delivering DME, such as a hospital bed, or other equipment. In some arrangements, there is only one hand grip. In one example, the hand grips 42, 44 can be slots sized to fit a hand comfortably. The size of the slots can be from about 1×4 inches to about 3×8 inches. In FIG. 3, the slots are shown as oval in shape. Other shapes are possible. In another example, separate hand grips can be bolted, riveted, or welded to bottom panel 40.

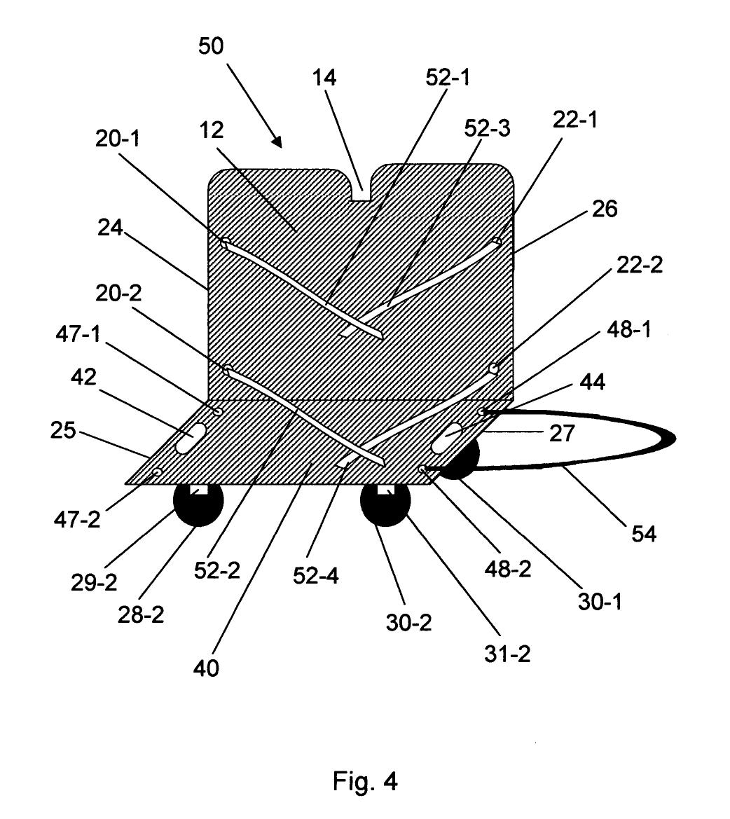

In another embodiment of the invention, as shown in the perspective view of FIG. 4, a carrier 50 contains only one side panel 12. The side panel 12-1 is attached approximately perpendicularly to a bottom panel 40. In some arrangements, the side panel 12 of the carrier 50 can be made of one or more pieces of continuous, solid material. In some arrangements, the side panel 12 can include joints so that the side panel can be folded or collapsed when desired. The material can be molded plastic or polymer, wood, a composite material, such as fiberglass, or a metal, such as aluminum, titanium, or steel. In one arrangement, sheet aluminum is used, as it offers a good combination of strength and light weight. The thickness of the aluminum sheet can be between about 0.08 and 0.25 inches. In other arrangements (not shown), the side panel 12 can have a basic frame structure, containing tubes or rods. There may or may not be mesh or netting attached to the frame structure. The mesh or netting can be made of any of the materials described above in FIG. 1 for the side panels 12-1, 12-2. Alternatively, the mesh or netting can be made of materials such as nylon, cotton, or polyester. The side panel can be between about 25 and 35 inches in length and between about 15 and 25 inches in height. In some arrangements, the height of the side panel can be adjustable.

A notch 14 can be provided in the top edge of the side panel 12, as has been described above in reference to FIG. 1. Extra stability for a typical hospital bed during transport can be provided by placing a crank handle of the bed in the notch 14. In some arrangements, rounded corners can be provided on the top edge of the side panel 12, as have been described above in reference to FIG. 1. In other arrangements, the corners can be square, angled or of any other shape.

There can be small holes 20-1, 20-2, near the rear edge 24 and small holes 22-1, 22-2 near the front edge 26, of the side panel 12. The holes 20-1, 20-2, 22-1, 22-2 provide a way for extension elements to couple to the side panel 12. The holes can be located anywhere along the height of the side panel 12 near the rear edge 24 and the front edge 26. Alternatively, there can be any number of holes such as 20-1, 22-1. Fittings (not shown) can be attached through the holes 20-1, 20-2, 22-1, 22-1. An example of a suitable fitting is an anchor shackle. Extension elements 52-1, 52-2, 52-3, 52-4 can be coupled to the fittings in holes 20-1, 20-2, 22-1, 22-2, respectively, or, in some arrangements, coupled directly to the holes themselves. The extension elements can be straps, ropes or ties, made of materials such as nylon, cotton, polyester, or composite materials. An example of a suitable strap is a nylon strap about 1.5 inches wide. The extension elements can be attached to one another by tying or through fittings and thus be used to secure DME or other equipment to the carrier. In some arrangements, the extension elements can be rigid bars made of rods or tubing.

An additional extension element 54 can be secured to the carrier 50 through fittings in holes 48-1, 48-2 adjacent the front edge 27 of the bottom panel 40. In some arrangements, the extension element 54 can be attached directly to holes 48-1, 48-2. The extension element can be used to pull and steer the carrier during transport. There can be additional holes 47-1, 47-1 adjacent the rear edge 25 of the bottom panel 40. The holes 47-1, 47-2, 48-1, 48-2 can be located any distance or distances from the rear edge 25 and the front edge 27 of the bottom panel 40, to allow for the attachment of extension elements as desired. Extension elements have been described in more detail above in reference to FIG. 1. In other arrangements, a flexible or rigid handle (not shown) can be connected to the bottom panel 40 through any of the holes 47-1, 47-2, 48-1, 48-2 as described above.

In the embodiment shown in FIG. 4, the carrier 50 includes 4 wheels. In the view shown in FIG. 4, only rear wheel 28-2 and front wheels 30-1, 30-2 are visible. There is a second rear wheel 28-2 that is hidden in this view by the bottom panel 40. Rear wheels 28-1 (not shown), 28-2, and front wheels 30-1, 30-2 are attached to the bottom panel 40 of the carrier 10 with rear fittings 29-1 (not shown), 29-2 and front fittings 31-1, 31-2, respectively. In other arrangements, there can be between 3 and 8 wheels. The wheels can be round bearing wheels that are suitable for transport over thresholds, steps, and gaps in the flooring. The wheels can be rigid casters or swivel casters, or some combination thereof In one arrangement, the rear wheels can be rigid casters and the front wheels can be swivel casters.

In some arrangements (not shown), a front axle and a rear axle with wheels attached can be used instead of individual wheels. In other arrangements one or more axles with wheels and additional individual wheels can be used. The diameters of the wheels can be between about 4 inches and 8 inches. It is desirable that the wheels be of sufficient size to roll over surface irregularities, such as door jambs, uneven ground, and connecting apparatus between a delivery truck and an outside surface, such as pavement, while the cart is carrying a heavy load, such as a hospital bed. Wheel fittings 29-1 (not shown), 29-2, 31-1, 31-2 and/or axle fittings can be attached to the bottom panel 40 in any number of ways, for example, by bolting, riveting or welding.

The side panel 12 can be attached to the bottom panel 40 in any number of ways, for example, by bolting, riveting, welding. In other arrangements, the side panel 12 can have tabs along its bottom panel, which can be inserted into corresponding holes in the bottom panel 40. These insertions can be made permanent by attachment methods as described above, or they can be non-permanent to allow easy disassembly of the carrier 50. In some arrangements, the side panel 12 can be attached to the bottom panel 40 with hinge mechanisms so that the side panel 12 can be folded down onto the bottom panel 40 for easy transport of the cart when it is not in use for carrying DME. The hinge mechanisms can have springs to hold the side panel 12 approximately perpendicular to the bottom panel 40 when desired. The bottom panel 40 can have a lining layer (not shown) along its panel surface. The side panel 12 can also have a lining layer (not shown) along its inside surface. The lining layers can be made of any material that will provide cushioning and protection against damage to the DME or other equipment carried within the carrier 50. Examples of materials that can be used for the lining layers include felt, carpeting, foam padding, artificial turf and plastics.

The bottom panel 40 has a width between about 12 and 30 inches. Widths greater than 30 inches are less useful as they do not fit easily through industrial and residential doorways. For applications where moving through doorways is not a concern, widths greater than 30 inches can be used. The bottom panel 40 can have a length between about 25 and 35 inches. This length can be made even longer as required for specific applications. The bottom panel 40 of the carrier 50 can be made of any material as described above for the side panel 12.

There can be hand grips 42, 44 near the rear edge 25 and the front edge 27, respectively, of the bottom panel. The hand grips 42, 44 can be used to pick up the carrier 40 and move it when it is empty, for example when returning the carrier 50 to a truck after delivering DME or other equipment. In some arrangements, there is only one hand grip. In one example, the hand grips 42, 44 can be slots sized to fit a hand comfortably. The size of the slots can be from about 1 by 4 inches to about 3 by 8 inches. In FIG. 4, the slots are shown as oval in shape. Other shapes are possible. In another example, separate hand grips can be bolted, riveted, or welded to bottom panel 40.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

I claim:

1. A cart for transporting a hospital bed, comprising:
a bottom panel having an approximately rectangular shape;
at least two wheels having a physical attachment to a first side of the bottom panel;
a first side panel having an approximately rectangular shape, the first side panel capable of connecting approximately perpendicular to the bottom panel adjacent a first edge of the bottom panel, the first side panel having an notch along a first edge of the first side panel, the notch adapted for immobilizing a component of a hospital bed frame when the frame is loaded on the cart.

2. The cart of claim B wherein the first side panel has a permanent connection to the bottom panel.

3. The cart of claim B wherein the first side panel has a hinged connection to the bottom panel.

4. The device of claim 1 wherein the notch has a depth between about two and six inches and a width between about one and three inches.

5. The cart of claim B, further comprising a lining layer on a second side of the bottom panel.

6. The device of claim 1 further comprising an axle as part of the physical attachment between the wheels and the first side of the bottom panel.

7. The cart of claim B, further comprising a lining layer on an inward-facing side of the first side panel.

8. The cart of claim B, further comprising a first coupling in the first side panel.

9. The cart of claim-1, further comprising a first extension element for securing the hospital bed during transport, the first extension element capable connecting to the first coupling in the first side panel.

10. The cart of claim-1 wherein the first extension element is selected from the group consisting of straps, ropes, ties, rods, and tubes.

11. The cart of claim B, further comprising a second side panel capable of connecting approximately perpendicular to the bottom panel adjacent a second edge of the bottom panel, the second edge approximately parallel to the first edge.

12. The cart of claim-1, further comprising a lining layer on an inward-facing side of the second side panel.

13. The cart of claim B, further comprising a first coupling in the bottom panel.

14. The cart of claim-1, further comprising a handle capable of connecting to the first coupling in the bottom panel.

15. The cart of claim B, further comprising a first hand grip adjacent a third edge of the bottom panel, the third edge approximately perpendicular to the first edge.

16. A cart for transporting a hospital bed, comprising:
a bottom panel having an approximately rectangular shape;
four wheels having a physical attachment to a first side of the bottom panel;
a first side panel capable of connecting approximately perpendicular to the bottom panel adjacent a first edge of the bottom panel, the first side panel having an notch along a first edge of the first side panel, the notch adapted for immobilizing a crank handle of a hospital bed frame when the frame is loaded on the cart; and
a second side panel capable of connecting approximately perpendicular to the bottom panel adjacent a second edge of the bottom panel, the second edge of the bottom panel approximately parallel to the first edge.

17. The cart of claim B, further comprising a lining layer on a second side of the bottom panel.

18. The device of claim B further comprising an axle as part of the physical attachment between the wheels and the first side of the bottom panel.

19. The cart of claim B, further comprising a lining layer on an inward-facing side of the first side panel and on an inward facing side of the second side panel.

20. The cart of claim B, further comprising a first coupling in the first side panel and a second coupling in the second side panel.

21. The cart of claim-1, further comprising a first extension element for securing the hospital bed during transport, the first extension element capable connecting to the first coupling in the first side panel.

22. The cart of claim-1 wherein the first extension element is selected from the group consisting of straps, ropes, ties, rods, and tubes.

23. The cart of claim B, further comprising a first hand grip adjacent a third edge of the bottom panel, the third edge approximately perpendicular to the first edge.
